(19) United States
(12) Patent Application Publication
(10) Pub. No.: US 2026/0369486 A1
(43) Pub. Date: Nov. 19, 2026

(54) Switching Device

(71) Applicant: TE Connectivity Solutions GmbH, Schaffhausen (CH)

(72) Inventors: Matthias KROEKER, Schaffhausen (CH); Hicham NIKIBOU, Schaffhausen (CH)

(73) Assignee: TE Connectivity Solutions GmbH, Schaffhausen (CH)

(21) Appl. No.: 19/672,810

(22) Filed: May 11, 2026

(30) Foreign Application Priority Data
May 14, 2025 (DE) 102025118539.5

(51) Int. Cl. H01H 9/44

(52) U.S. Cl. CPC H01H 9/44

(57) ABSTRACT

A switching device for switching an electrical circuit between a closed position, in which a pair of contact carriers is in contact, and an open position, in which the pair of contact carriers is spaced apart along a contact direction. The switching device includes: a contact member on a first contact carrier for electrically contacting a mating contact on a second contact carrier in the closed position; a blowout magnet generating a blowout magnetic field transversely to the contact opening, the blowout magnetic field deflecting an electric arc between a contact surface of the contact member and the mating contact in the open position; and a magnetic shield on the first contact carrier, the magnetic shield surrounds at least in part the contact member in a circumferential direction perpendicular to the contact direction and guides the blowout magnetic flux around the contact surface.

### CROSS-REFERENCE TO RELATED APPLICATION

This application claims the benefit of German Patent Application No. 102025118539.5 filed on May 14, 2025, in the German Patent Office, the whole disclosure of which is incorporated herein by reference.

### FIELD OF THE INVENTION

The object described herein relates to a switching device. The description relates in particular to a switching device having a blowout magnet for electric arc extinction.

### BACKGROUND OF THE INVENTION

A switching device is an electrical component used for switching electrical circuits on and off. A switching device can be, for example, a disconnector, a contactor, a relay, or a circuit breaker. In a switching device, a pair of contact carriers are in contact in a closed position. The switching device can therefore conduct current. In an open position, the pair of contact carriers are spaced apart along a contact direction. The electrical circuit is therefore interrupted, since air or other insulating medium is arranged in a contact gap between the pair of contact carriers.

In particular, switching devices can be used for switching high currents and/or high voltages, e.g. several tens of kA or several kV. Typically, in the range of high currents and/or high voltages, switching devices having a solenoid coil, a lifting armature, and contact members are used for switching or interrupting electrical circuits. They provide very high switching speeds and can interrupt loads of up to several kA.

For switching high currents and/or voltages, switching devices with electric arc extinction devices are advantageous. To reduce electric arc damage, a blowout magnet, e.g. a permanent magnet or an electromagnet, can be used to deflect the switching arc between the contacts of a switching device by way of the Lorentz force acting upon the electric arc to increase the voltage drop of the electric arc above the supply voltage and consequently to extinguish the electric arc.

A blowout magnetic field is arranged perpendicular to the switching contacts. When the switching contacts are opened, a switching arc forms at higher direct currents that lead to rapid wear of the contacts. However, due to the presence of the external magnetic field, the Lorentz force acts upon the electric arc, so that it is pushed (“blown”) away from the magnet and thereby elongated. For alternating currents, a blowout magnet is not usually used. This is presently achieved by the self-field.

In particular, the deflected electric arc extinguishes more rapidly since it cools down more quickly due to the larger surface area and the ionized air loses its conductivity more quickly.

For switching devices of this kind, it is furthermore common to define a limit value for the short-circuit current that is not to be switched but is to be carried (e.g. 20 kA) and up to which a current flow must be maintained for a given time (e.g. 2 ms) in the closed position At high short-circuit currents, separation of the contacts at the contact point occurs since the effect of levitation can then exceed the closing force of the switching device. It is known that the current flowing toward the contact point is antiparallel to the current flowing away from the contact point, which leads to a repulsion at the contact point.

### SUMMARY OF THE INVENTION

The invention is based on the task of improving the requirement for the resistance capability for short-circuit currents in the closed position. A further requirement is to extinguish electric arcs in the open position.

The above tasks are satisfied by the object of the independent claim. Advantageous further developments are the object of the dependent claims.

The invention is generally satisfied by a magnetic shield that surrounds at least in part a contact member in the circumferential direction.

At high currents, e.g. in the event of a short circuit, levitation leads to the opening of the contacts. As long as the electric arc forming between the contacts is held in the contact gap, the voltage and energy drop is minor, and the switching device survives the process. If the magnetic field in the event of a short circuit pulls the electric arc out of the contact gap created by levitation, a very large voltage drop arises. This also leads to a very large energy conversion, so that the switching device can explode. The magnetic shield guides a magnetic field around the contact surface and allows the electric arc to remain in the contact gap in the closed position and to be deflected in the open position.

In other words, the requirements for the switching device for switching high currents and for short-circuit resistance capability are contradictory with regard to the electric arc. The magnetic shield can resolve these contradictory requirements. Switching devices are designed for switching high loads. This requires that the electric arc be rapidly forced from the contact gap by a magnetic field. Switching devices must also be short-circuit proof for a limited time. In this case, the electric arc should remain in the contact field. Due to the magnetic shield arranged around the contact member, the magnetic field in the contact gap can be reduced locally. The electric arc is then not forced from the contact gap but remains between the contact members. As a result, the electric arc voltage remains small.

The requirements for the switching and short-circuit capacity therefore require, without further measures such as the magnetic shield, a compromise in which one or the other requirement can be met only in part. In order to resolve the contradiction between high electric arc mobility with open contacts and minimal electric arc mobility with minimally open contacts, a magnetic shield is presently discussed that shields the magnetic field in the immediate vicinity of the contacts. Hereafter, the electric arc mobility is also referred to as the dwell time of the electric arc in the contact gap. The height of this ring can be somewhat less than the contact height. This allows the dwell time of the electric arc in the contact gap during levitation to be increased, i.e. the electric arc mobility is minimal. When the contacts are fully opened for switching off, the effect of the shield is then minimal and the electric arc is maximally mobile, i.e. the dwell time of the electric arc in the contact gap is reduced.

### BRIEF DESCRIPTION OF THE DRAWINGS

For a better understanding of the present invention, it shall be explained in more detail using the exemplary embodiments shown in the following figures. Same parts are provided with same reference numerals and same component designations. In addition, individual features or combinations of features of the different examples shown and described can themselves also represent independent inventive solutions or those according to the invention.

The present invention shall now be described by way of the figures.

FIG. 1 shows a schematic cross-sectional view through a switching device with a magnetic shield.

FIG. 2 shows a side view of a switching device in the closed position during levitation.

FIG. 3 shows a side view of FIG. 2 in the open position.

FIG. 4 shows an electric arc in the view of FIG. 2.

FIG. 5 shows an exemplary illustration of a switching device in the open position.

FIG. 6 shows a detail of FIG. 5.

FIG. 7 shows the switching device of FIG. 6 in the closed position.

FIG. 8 shows a detail of FIG. 7.

FIG. 9 shows a contact bridge of the switching device of FIG. 5.

FIG. 10 shows a contact arm of the switching device of FIG. 5.

FIG. 11 shows a magnetic shield according to an exemplary illustration.

FIG. 12 shows a schematic cross-sectional view of a switching device with a blowout magnet.

FIG. 13 shows a switching device in the closed position during levitation.

FIG. 14 shows the switching device of FIG. 13 in the open position.

FIG. 15 shows an electric arc in the switching device in the cases of FIGS. 13 and 14.

### DETAILED DESCRIPTION OF EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

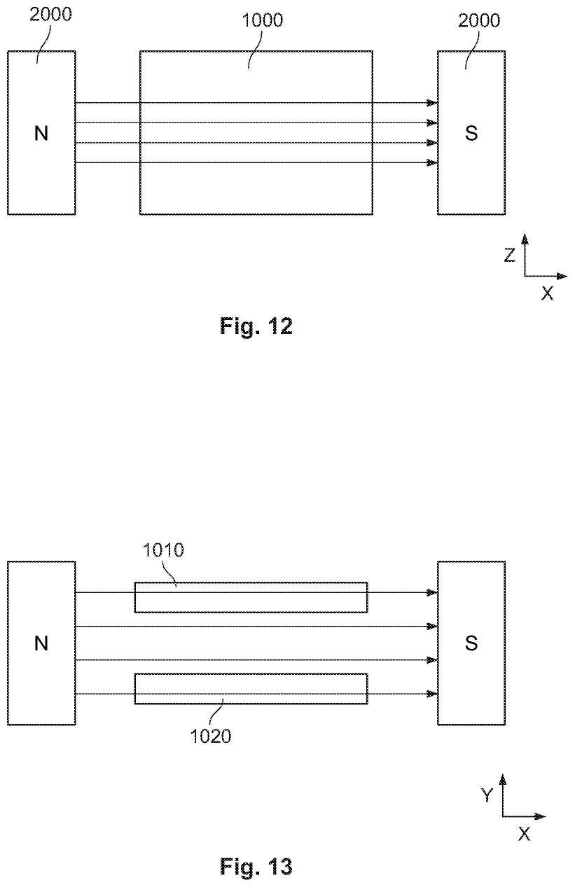

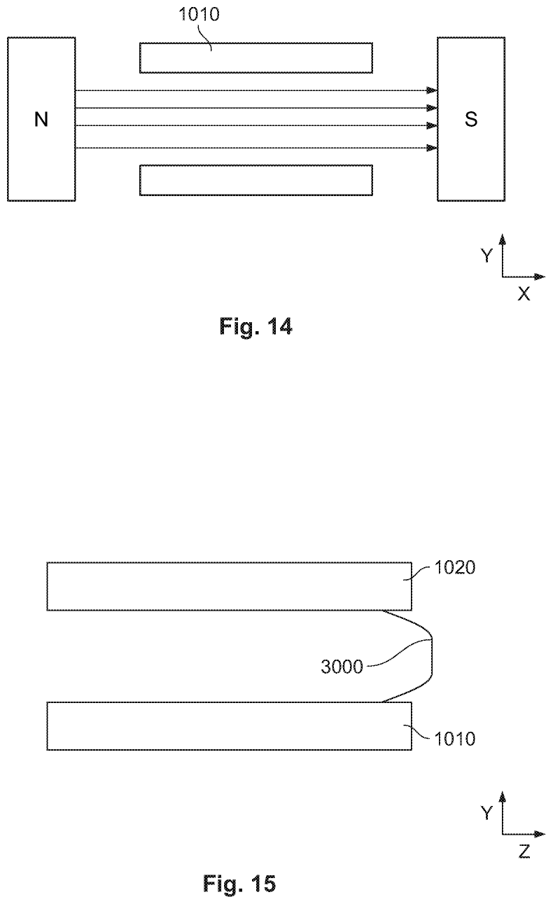

The effects of a switching device with a blowout magnet shall be explained, for example, with reference to FIGS. 12 to 15. FIG. 12 shows a switching device 1000 with a blowout magnet 2000. The blowout magnet 2000 generates a blowout magnetic field that extends transverse to the switching direction of the switching device. FIGS. 13 and 14 show the switching device in a side view.

In a closed state, a pair of contact carriers 1010, 1020 of the switching device are arranged along the contact direction. Due to levitation, also referred to as electromagnetic levitation or repulsion, a contact gap can arise in the event of a short circuit.

In the open case shown in FIG. 14, the pair of contact carriers 1010, 1020 is arranged remote from each other, i.e. spaced apart. In both cases, an electric arc 3000 that carries current in the direction of the contact direction Y is influenced by the magnetic field which presently extends in the X-direction by way of example. According to the Lorentz force, electric arc 3000 is deflected perpendicular to the current direction and to the magnetic field direction, i.e. in the Z-direction as shown in FIG. 15. As shown in FIG. 15, electric arc 3000 is deflected in the closed position during levitation and in the open position because a magnetic field is present between the contact carriers.

In the present description, aspects shall first be described, where the figures are mentioned by way of example.

A first aspect relates to a switching device for switching an electrical circuit between a closed position, in which a pair of contact carriers is in contact, and an open position, in which the pair of contact carriers is spaced apart along a contact direction.

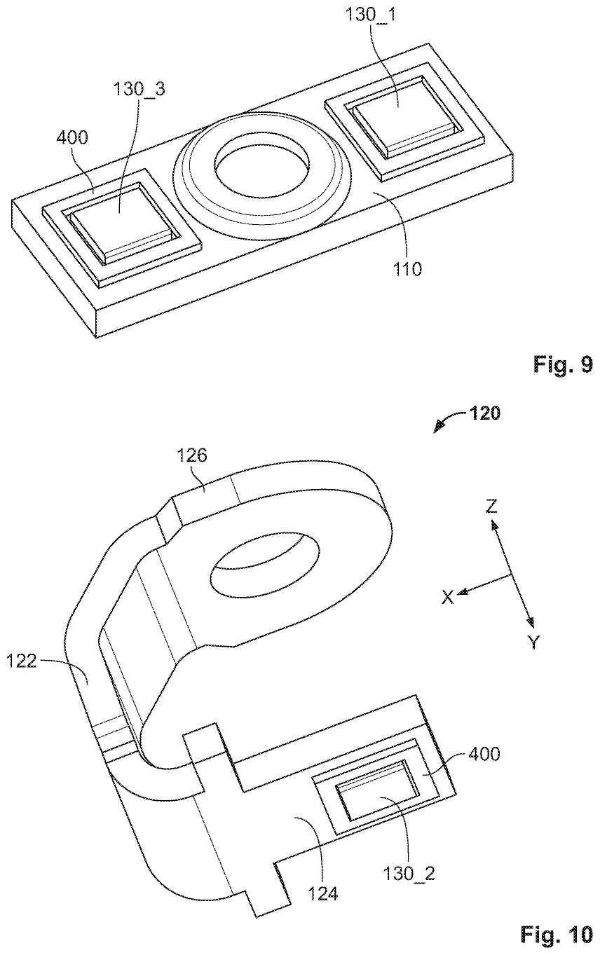

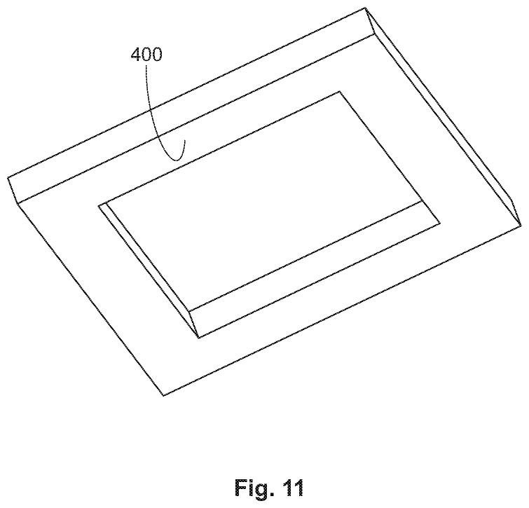

A contact carrier herein means a mechanical component that holds, positions, or guides one or more electrical contacts, for example, contact members. A contact carrier can be, for example, a contact bridge 110 as shown in FIG. 9 or a contact arm 120 as shown in FIG. 10.

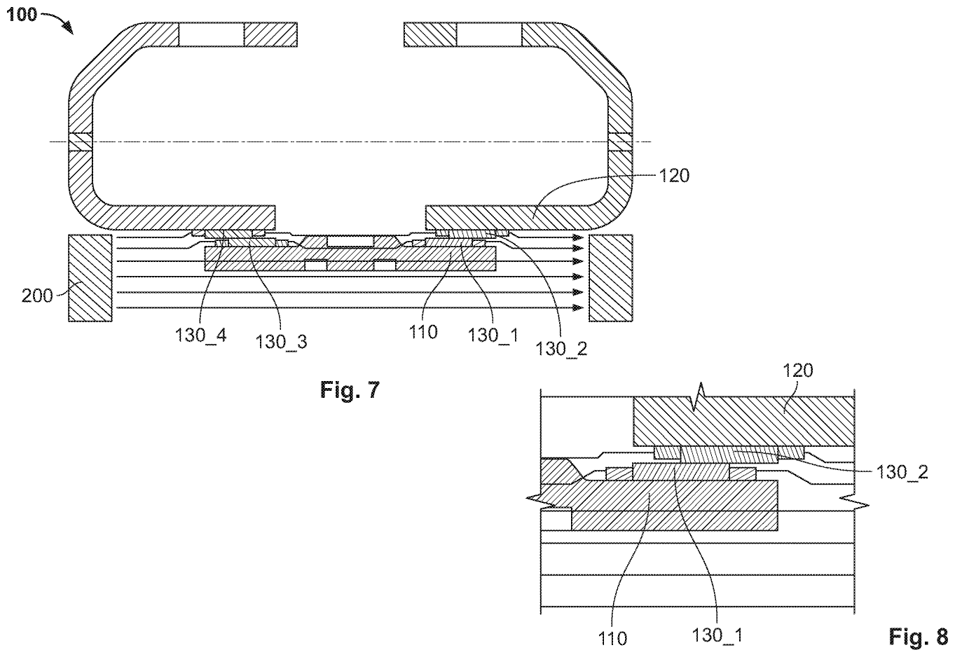

Contact carriers 110, 120 are shown in FIG. 7 in the closed position. Contact bridge 110 there is in contact with contact arm 120. For example, contact bridge 110 is connected via contact members 130_1, 130_2 in an electrically conductive manner to contact arms 120. Furthermore, FIGS. 8 and 4 show that the contact carriers are connected via contact members 130_1, 130_2 in an electrically conductive manner in the closed position. In the event of levitation, in which an opening of some 10 μm arises in the closed position at high short-circuit currents, this short-circuit current is carried by electric arc 300 between the contact carriers.

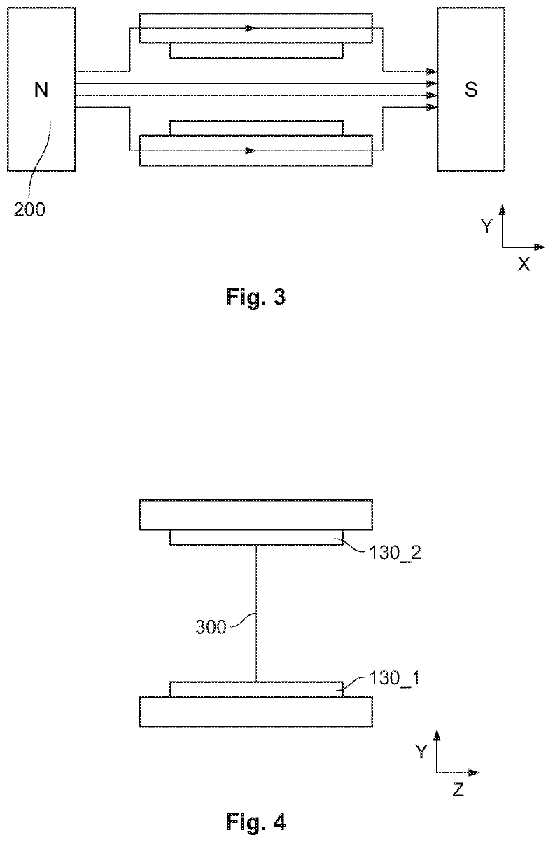

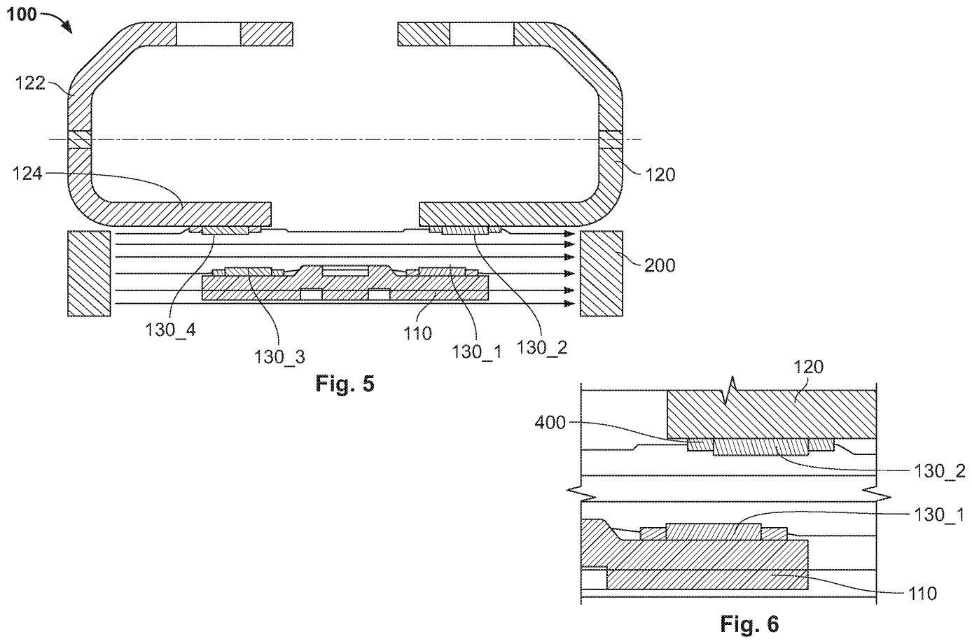

The contact carriers are shown in FIGS. 3 and 5 in the open position. The pair of contact carriers there is spaced apart along contact direction Y. This distance, for example 2.8 mm, is much larger, for example, by a factor of 100, than a spacing produced by levitation for high short-circuit currents.

According to the first aspect, the switching device comprises a contact member arranged on a first contact carrier of the pair of contact carriers. This contact member enables electrical contacting of a mating contact on a second contact carrier of the pair of contact carriers in the closed position.

A contact member is a component that is connected fixedly, for example, non-detachably, to the first contact carrier and that serves as an electrical connection and at the same time as a mating contact to the second contact carrier. It comprises conductive material, e.g. copper or brass, and can be provided with a wear-resistant contact layer at the contact point, for example, made of silver or a silver alloy, in order to minimize wear and contact resistances. It is typically a flat element, for example, a plate-shaped, mostly rectangular or round component with a significantly greater length and width as compared to the thickness, wherein the thickness is measured in contact direction Y.

Contact members 130_1, 130_2 are shown particularly well in FIGS. 6 and 8. The contact members there project in connection direction Y from contact carriers 110, 120. The thickness in connection direction Y is small compared to the extension in comparison to a magnetic field direction X and an electric arc deflection direction Z.

According to the first aspect, the switching device comprises blowout magnets. The blowout magnet generates a blowout magnetic field. The blowout magnetic field deflects the electric arc between a contact surface of the contact member and the mating contact in the open position. For the description of the blowout magnetic field, reference is made to the above description relating to FIGS. 12 to 15. In the present description, the blowout magnetic field serves to deflect an electric arc 300 in the open position, as shown in FIG. 15, transverse to the contact direction. Blowout magnets 200 are shown by way of example in FIGS. 1 to 3, 5, and 7.

The magnets for the blowout magnet in FIGS. 1 to 3 and 5 and 7 are shown schematically there. The blowout magnet can comprise, for example, two bar magnets. They can be connected on the rear side in the circumferential direction of the contact direction by way of plates, not shown. Alternatively, a horseshoe magnet, not shown, can also be used. The blowout magnet can also be realized as an electromagnet, for example, by one or two coils.

It is to be noted in particular that a continuous blowout magnetic field is generated there. This continuous blowout magnetic field is generated, for example, by a permanent magnet. Permanent magnets are typically used.

According to the first aspect, the switching device comprises a magnetic shield on the first contact carrier. The magnetic shield surrounds the contact member at least in part in a circumferential direction perpendicular to contact direction Y. The magnetic shield guides the magnetic flux of the blowout magnetic field around the contact surface of the contact member.

The magnetic resistance in the magnetic shield can be described according to the following formula (1):

R=l/(μ0 μr A)

Where l is the length of the magnetic circuit, A is the cross-sectional area of the magnetic conductor through which the magnetic field passes, and μ0μr is the magnetic permeability of the material. Where μr is the relative permeability of the material and μ0 is the vacuum permeability. Since the magnetic field propagates along the path of least resistance, the magnetic shield attracts the blowout magnetic field and reduces the magnetic field strength in the contact gap. In the closed state, levitation in the event of a short circuit can produce a contact gap with a small extension in the contact direction. The effect of the magnetic shield is then large. On the other hand, in the case of the open position, the effect of the magnetic shield is negligible.

Magnetic shield 400 is shown, for example, in FIGS. 5 to 10 in connection with contact members 130_1, 130_2. In FIG. 11, magnetic shield 400 is shown, for example, as a one-piece element. Magnetic shield 400 is attached to the contact carrier, for example, in a non-detachable manner.

As shown in particular in FIG. 6, the magnetic shield abuts close against the contact member. In particular, the magnetic shield can touch the contact member. The magnetic shield does not necessarily have to be placed tightly around the contact. In particular, an encompassing ring can be designed having a large inner diameter so that the shielding does not touch the mating contact members despite tolerance-related contact offset. As shown in FIGS. 9 and 10, a spacing perpendicular to contact direction Y can be present between magnetic shield 400 and contact members 130_1, 130_2.

As furthermore shown by way of example in FIG. 6, the magnetic shield projects less far in connection direction Y than contact members 130_1, 130_2. Contact members 130_1, 130_2 therefore do not come into electrically conductive contact with corresponding mating contacts 130_1, 130_2 in the closed position as shown in FIG. 8. There is a gap between magnetic shield 400 and oppositely disposed contact member 130_1, 130_2, even in the closed state. Alternatively, in an example not shown, the magnetic shield can surround both contact members 130_1, 130_2 in connection direction Y in the closed state. In this case, contact members 130_1, 130_2 do not contact the magnetic shield in the closed case, i.e. they are aligned matching in their circumference.

This is understood to mean that magnetic shield 400 surrounds contact members 130_1, 130_2 in the circumferential direction, that magnetic shield 400 extends annularly around contact members 130_1, 130_2.

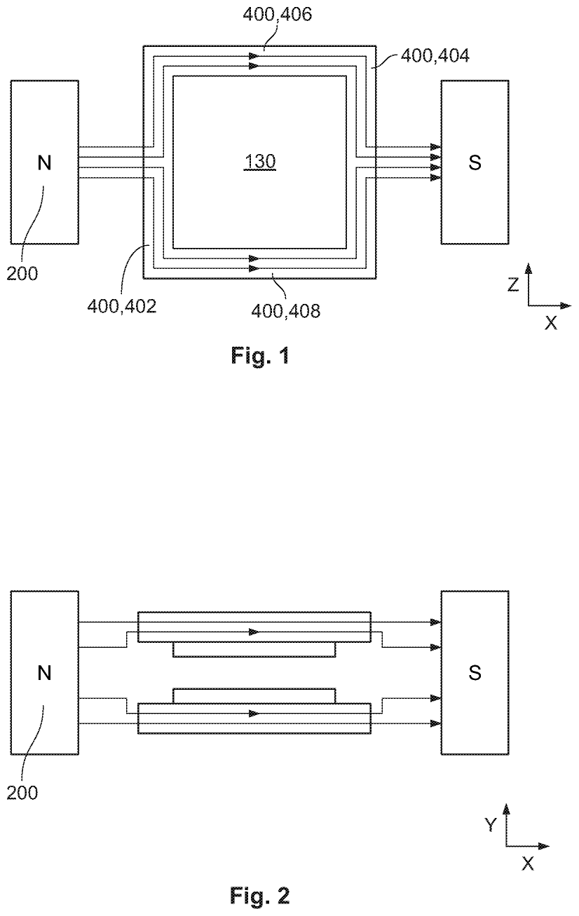

In particular, as shown in FIG. 1, parts 402, 404 of magnetic shield 400 extend at circumferential edges of contact members 130 that are disposed oppositely to each other transverse to the north-south axis of the magnetic field of blowout magnet 200. As shown, for example in FIG. 2, these parts 402, 404 can guide the magnetic field away from the contact gap formed by levitation in the event of a short circuit, and the magnetic field is guided around the contact surface of the contact members.

Furthermore, these two oppositely disposed parts 402, 404 of the magnetic shield can be connected, for example, via connector members 406, 408. This results in a magnetic short circuit and the magnetic field is guided around the contact members in the circumferential direction. This is shown, for example, in FIG. 1.

A second aspect relates to the switching device according to aspect 1, wherein the magnetic shield is a ring that completely surrounds the contact member. This is shown, for example, in FIG. 11.

A third aspect relates to the switching device according to one of the preceding aspects, wherein the magnetic shield is soft magnetic material. Such materials can have a relative permeability μr greater than or equal to 1000. For example, ferromagnetic material, such as a Mu-metal, ferromagnetic nanocrystalline metals, and/or ferromagnetic amorphous metals can be used.

A fourth aspect relates to the switching device according to one of the preceding aspects, wherein an interruption distance in the contact direction between the contact surface of the contact member and the mating contact in the open position is greater than or equal to 2 mm. The interruption distance there is the distance in the open position. the latter arises from DIN EN IEC 60664-1 VDE 0110-1:2022-07, Isolationskoordination für Betriebsmittel in Niederspannungs-Stromversorgungssystemen (Insulation coordination for equipment in low-voltage current supply systems). The interruption distance can also be greater than or equal to 3 mm. Additionally or alternatively, the interruption distance in the open position can be less than or equal to 10 mm, optionally 4 mm. This upper limit can arise from installation space requirements for the switching device.

A fifth aspect relates to the switching device according to one of the preceding aspects, wherein a step height between the contact surface of the contact member and a surface of the magnetic shield in the direction of the contact carrier is less than or equal to 0.4 mm. The step height between the contact surface of the contact member and a surface of the magnetic shield is the recess in the surface, as shown for example in FIG. 6. It is measured in the contact direction Y from the surface disposed opposite the mating contact. This step height allows the magnetic shield not to come into contact with the mating contact or a magnetic shield of the mating contact. The optimal step height is between 0.05 mm and 0.3 mm. A small step height ensures adequate shielding of the blowout magnetic field above and below the front faces of the shielding ring. This requirement can arise, for example, from manufacturing techniques and allows for the erosion of the contact member over the service life. An excessively small step height distance can lead to the magnetic shield coming into electrical contact with the mating contact.

In an alternative not shown, the magnetic shield can project beyond the contact member in the direction of the mating contact. The mating contact is therefore also shielded in the closed position. For this alternative, it is assumed that the mating contact meets the contact surface centrally, or that the inner diameter of the shield is greater than the largest assumed contact offset.

A sixth aspect relates to the switching device according to one of the preceding aspects, wherein the mating contact on the second contact carrier of the pair of contact carriers is a mating contact member and a mating contact shield is arranged on the second contact carrier, wherein the mating contact shield surrounds at least in part the mating contact member in the circumferential direction perpendicular to the contact direction. The mating contact shield can be a magnetic mating contact shield for guiding the blowout magnetic field around a mating contact surface of the mating contact member. The mating contact shield can also be an insulating mating contact shield, for example, to insulate the magnetic shield that projects beyond the contact member in the direction of the mating contact.

For the description of the mating contact member, reference is made to the above description of the contact member. For the description of the mating contact shield, reference is made to the above description of the magnetic shield of the contact member.

A seventh aspect relates to the switching device according to one of the preceding aspects, wherein one side of the pair of contact carriers is a contact bridge, wherein two contact members are arranged on the contact bridge. For example, each of the contact members is surrounded at least in part by a magnetic shield in the circumferential direction. For the description of the magnetic shields, reference is made to the above description of the magnetic shield of the contact members.

A contact bridge 110, as shown, for example, in FIG. 9, in a switching device such as a contactor can be a conductive component that has the function of establishing or interrupting the electrical current between two fixed mating contacts. Two contact members 130_1 and 130_3 are arranged on one side and are each surrounded by a magnetic shield 400. The contact bridge can be mounted in a mechanically movable manner and can be pressed against the fixed mating contacts by the drive of the contactor—usually an electromagnetic actuator—in order to close the electrical circuit. When switching off, the contact bridge is again moved away from the mating contacts, whereby the electrical circuit is opened. The contact bridge often comprises electrically conductive carrier material and/or can be provided with a current-conducting layer (e.g. silver alloys).

An eighth aspect relates to the switching device according to one of the preceding aspects, wherein one of the pair of contact carriers comprises two contact arms, wherein a contact member is arranged on each of the contact arms. For example, each of the two contact members on the contact arm is surrounded by a magnetic shield in the circumferential direction. For the description of the magnetic shields, reference is made to the above description of the magnetic shield of the contact member.

Each of the contact arms can serve as a mating contact for the contact bridge described above and can be fixedly connected to the two electrical connections of the switching device. A contact arm 120 is shown by way of example in FIG. 10. Contact arm 120 carries contact member 130_2, against which, for example, the movable contact bridge is pressed when the contactor is actuated in order to close the electrical circuit. In the open state, there is no electrical contact between the contact bridge and the contact arm, whereby the current flow is interrupted. The contact member 130_2 can comprise a magnetic shield 400.

A ninth aspect relates to the switching device according to the eighth aspect, wherein contact arm 120 comprises a curved portion 122. For example, curved portion 122 is C-shaped in cross-section. A first leg 124 is used for contacting the mating contact and comprises, for example, contact member 130_2. A second leg 126 is connectable to the electrical circuit. Curved portion 122 is arranged between first leg 124 and second leg 126.

A tenth aspect relates to the switching device according to the ninth aspect, wherein the openings of the curved portions face each other. This is shown by way of example in FIGS. 5 and 7.

As shown by way of example in FIG. 5, the current flow in arm 124 is parallel and in the same direction as the current flow in movable bridge 110. The current flow in curved portion 122 is perpendicular to the current flow in movable bridge 110. This results in an attracting force between arm 124 and bridge 110 which counteracts the repulsive force between curved portion 122 and bridge 110.

An eleventh aspect relates to the switching device according to one of the aspects 7 to 10, wherein the blowout magnet is arranged such that a north-south axis of the blowout magnet lies in the direction of a connecting line of two contact members 130_1, 130_3 of contact bridge 110 and/or of two contact members 130_2, 130_4 of two contact arms 120.

As shown by way of example in FIG. 7, the magnetic field extends parallel to the X-axis. The electric arcs form in the contact direction, i.e. in the Y-direction. The current flow of the electric arcs is therefore in the Y-direction and perpendicular to the magnetic field. According to the Lorentz force, the electric arc is there then directed in the Z-direction. When the electric arc between contacts 130_1 and 130_2 is directed, for example, in the positive Z-direction, the electric arc between contacts 130_4 and 130_3 is directed in the negative Z-direction, since the current flows in different directions.

The switching device can advantageously also comprise an extinction device. The extinction device is not shown in the figures and can advantageously be located in the Z-direction relative to the contacts. It is advantageously arranged on both sides of the contact pairs. This enables extinction independent of the direction of current flow in the switching device.

A twelfth aspect relates to the switching device according to one of the preceding aspects, wherein one of the pair of contact carriers is a movable contact and the other of the pair of contact carriers is a fixed contact, wherein the movable contact moves in the direction of the contact direction relative to the fixed contact during switching. The movable contact carrier is, for example, contact bridge 110 illustrated in FIGS. 5 and 7. The fixed contact carriers are contact arms 120 shown, for example, in FIGS. 5 and 7.

A thirteenth aspect relates to the switching device according to one of the preceding aspects, wherein the switching device is bidirectional. Bidirectional means that the switching device can be operated in both load current directions.

A fourteenth aspect relates to the switching device according to one of the preceding aspects, wherein, in the closed position, a current of greater than or equal to 15 kA flowing through the switching device does not interrupt an electrical connection between the contact member and the mating contact. A time-limited short-circuit current-carrying capacity of at least 20 kA is ensured. High currents of >20 kA cause the contacts to be pushed open by electromagnetic repulsion forces. The forces are of short range, i.e. the resulting contact gap is small. In general, the contact gap must be large for even a weak magnetic field to be able to deflect the electric arc. However, the short-circuit current is so large that the electric arc is torn out of the gap even at a low magnetic flux density. The magnetic shield now reduces the magnetic field of the blowout magnet. This prevents the electric arc from leaving the gap and the voltage drop and power conversion from becoming too large.

A fifteenth aspect relates to the switching device according to one of the preceding aspects, wherein, in the open position, a current of less than or equal to 2.5 kA between the contact member and the mating contact is interrupted. Currents of up to 2.5 kA can therefore be interrupted.

The figures have so far been described only by way of example and shall be described in detail below to show further detailed aspects.

A switching device 100 is shown as an example in FIGS. 5 to 8. The switching device for switching the electrical circuit is shown in the closed position in FIGS. 7 and 8, wherein FIG. 8 shows a detail of FIG. 7. Switching device 100 is shown in the open position in FIGS. 5 and 6, wherein FIG. 6 shows a detail of FIG. 5. In other words, a switching device for switching an electrical circuit between a closed position, in which a pair of contact carriers are in contact, and an open position, in which the pair of contact carriers is spaced apart along a contact direction, is shown.

The switching device according to the example comprises two fixed contact arms 120, wherein a contact arm is shown in detail in FIG. 10. The switching device further comprises a movable contact bridge 110 which is shown in detail in FIG. 7. In other words, one of the pair of contact carriers is a movable contact and the other of the pair of contact carriers is a fixed contact, wherein the movable contact moves in the direction of the contact direction relative to the fixed contact during switching.

Contact arm 120 shall now be described in detail with reference to FIG. 10. Contact arm 1200 comprises a curved portion 122, a first leg 124, and a second leg 126. First leg 124 is used for contacting the oppositely disposed contact bridge. A contact member 130_2 is arranged on the first leg. Contact member 130_2 is surrounded by a magnetic shield 400. Magnetic shield 400 is shown in FIG. 11. The contact arm at the second leg 126 furthermore comprises a connecting device for connecting to the electrical circuit. The contact arm has substantially the shape of a C. The second contact arm is configured in the same way as the first contact arm. Both contact arms are arranged in switching device 100 as shown in FIGS. 5 and 7, with their open sides facing each other. In other words, one of the pair of contact carriers comprises two contact arms, wherein a contact member is arranged on each of the contact arms. For example, each of the contact members is surrounded at least in part by a magnetic shield in the circumferential direction. Each of the contact arms has a curved portion. In particular, the openings of the curved portions face each other.

Contact bridge 110 is described with reference to FIG. 9. Contact bridge 100 comprises a first contact member 130_1 and a second contact member 130_3. Each of contact members 130_1 and 130_3 is surrounded by a magnetic shield 400. Not shown is an armature with which contact bridge 110 can be moved. In other words, one of the pair of contact carriers is a contact bridge, wherein two contact members are arranged on the contact bridge, wherein each of the contact members is surrounded at least in part by in the circumferential direction a magnetic shield.

Contact bridge 110 and contact arms 120 are shown in the open position in FIG. 5 and in the closed position in FIG. 7, respectively. The contact bridge there moves along contact direction Y by an armature, not shown.

Switching device 100 of the example furthermore comprises a blowout magnet 200. Blowout magnet 200 generates a magnetic field that is perpendicular to contact direction Y. In other words, the switching device comprises a blowout magnet that generates a blowout magnetic field transverse to the contact opening, wherein the blowout magnetic field deflects an electric arc between a contact surface of the contact member and the mating contact in the open position.

In particular, the magnetic field extends along a longitudinal orientation of contact bridge 110, presently the X-direction. It therefore extends along an arrangement direction of the two contact members on the contact bridge. An electric arc that forms in the open state is therefore moved out of the contact gap in a direction perpendicular to contact direction Y and magnetic field direction X, namely presently in the Z-direction. The extension of the electric arc leads to faster extinction of the electric arc and to a reliable contact interruption. In other words, the blowout magnet is arranged such that a north-south axis lies in the direction of a connecting line of the two contact members of the contact bridge and/or the two contact members of the two contact arms.

In the closed state shown in FIGS. 7 and 8, electromagnetic repulsion can produce an unintentional small contact gap in the event of a short circuit. When the short-circuit current sets in, the contacts lift a few 1/100 mm and the electric arc burns in the contact gap. If the gap is narrow enough and the effective magnetic field is small, the plasma remains stationary in the contact gap. For example, the voltage drop is then <50 V per contact. However, if the magnetic field is too large, the plasma is torn out of the gap and the voltage drop rises sharply, and the component is destroyed.

In other words, the influence of the magnetic field of blowout magnet 200 on an electric arc between contact members 130_1 and 130_2 and/or between contact members 130_3 and 130_4 in the closed position is to be reduced. This is achieved by magnetic shield 400 being located in the circumferential direction around the contact members.

A cross-section through contact member 130 and shield 400 is shown schematically in FIG. 1. The magnetic flux is guided in magnetic shield 400. In other words, it is guided around contact member 130. This leads to the magnetic field strength, as shown in FIG. 2, being reduced in the contact gap produced by levitation. As a result, as shown in FIG. 4, an electric arc remains between contact members 130_1 and 130_2. It follows therefore that switching device 100 in the closed position remains electrically connected through electric arc 300, even when levitation occurs. The electric arc foot points are initially located on the contact members, i.e. the electric arc burns between the contact members. As already explained, it is important to keep the plasma in the contact gap. When the plasma breaks out and the current flows from foot point to foot point outside the contact gap, the voltage rises.

Simulations were performed for the switching device as in FIGS. 7 to 10 with and without a shield. In the closed position, the magnetic flux in the contact region is 51 mT without a shield and 22 mT with a shield. In the closed position, the magnetic flux in the contact region is 77 mT without a shield and 92 mT with a shield. In the open position, shown schematically in FIG. 3, the magnetic flux between the contact members is even slightly increased by magnetic shield 400 and blowout magnet 200 can continue to push the electric arc out of the contact gap.

For this simulation it was assumed that each pair of contact carriers comprises a contact member. Furthermore, each contact carrier has a magnetic shield that is a ring, as shown in FIG. 11, and completely surrounds the contact carrier. Each magnetic shield consists of soft magnetic material. An interruption distance in the contact direction between the contact surfaces of the contact members is >2.0 mm in the open position. A step height between the contact surface of the contact member and a surface of the magnetic shield in the direction of the contact carrier is 0.2 mm.

In particular, the arrangement of the magnetic field in the X-direction enables a bidirectional switching device in which, in the closed position, a short-circuit current of >15 kA can flow through the switching device without the current flow and the associated power conversion destroying the component. This furthermore enables a switching device in which, in the open position, a current of 2.5 kA between the contact member and the mating contact is interrupted.

It is to be understood that, with reference to the figures, a movable contact arrangement with two interruptions has been shown. Alternatively the switching device can also be configured with only one interruption.

It is to be understood that a magnetic shield has been shown with reference to the figures that does not project beyond the contact member. Alternatively the shield can also project beyond the contact member.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed is:

1. A switching device for switching an electrical circuit between a closed position, in which a pair of contact carriers is in contact, and an open position, in which said pair of contact carriers is spaced apart along a contact direction, said switching device comprising:
a contact member on a first contact carrier of said pair of contact carriers for electrically contacting a mating contact on a second contact carrier of said pair of contact carriers in the closed position;
a blowout magnet generating a blowout magnetic field transverse to the contact opening, wherein the blowout magnetic field deflects an electric arc between a contact surface of said contact member and said mating contact in the open position; and
a magnetic shield on said first contact carrier, wherein said magnetic shield surrounds at least in part said contact member in a circumferential direction perpendicular to said contact direction, such that said magnetic shield can guide the blowout magnetic flux around said contact surface.

2. The switching device according to claim 1, wherein said magnetic shield is a ring that completely surrounds said contact member.

3. The switching device according to claim 1, wherein said magnetic shield comprises soft magnetic material.

4. The switching device according to claim 1, wherein an interruption distance in said contact direction between the contact surface of said contact member and said mating contact in the open position is greater than or equal to 2 mm.

5. The switching device according to claim 1, wherein a step height between the contact surface of said contact member and a surface of said magnetic shield in the direction of said contact carrier is less than or equal to 0.4 mm,
wherein optionally the step height in said contact direction is greater than or equal to 0.1 mm such that, in the closed position, the surface of said contact member does not touch said mating contact.

6. The switching device according to claim 1, wherein said magnetic shield projects beyond said contact member in the direction of said mating contact.

7. The switching device according to claim 1, wherein said mating contact on said second contact carrier of said pair of contact carriers is a mating contact member, and a mating contact shield is arranged on said second contact carrier, wherein said mating contact shield surrounds at least in part said mating contact member in the circumferential direction perpendicular to said contact direction.

8. The switching device according to claim 1, wherein one of said pair of contact carriers is a contact bridge, wherein two contact members are arranged on said contact bridge, preferably wherein each of said contact members is surrounded at least in part by a magnetic shield in the circumferential direction.

9. The switching device according to claim 1, wherein one of said pair of contact carriers comprises two contact arms, wherein a contact member is arranged on each of said contact arms, preferably wherein each of said contact members is surrounded at least in part by a magnetic shield in the circumferential direction,

10. The switching device according to claim 9, wherein each of said contact arms comprises a curved portion.

11. The switching device according to claim 10, wherein openings of said curved portions face each other.

12. The switching device according to claim 7, wherein said blowout magnet is arranged such that a north-south axis lies in the direction of a connecting line of said two contact members of said contact bridge and of said two contact members of said two contact arms.

13. The switching device according to claim 7, wherein said blowout magnet is arranged such that a north-south axis lies in the direction of a connecting line of said two contact members of said contact bridge or of said two contact members of said two contact arms.

14. The switching device according to claim 1, wherein one of said pair of contact carriers is a movable contact and the other of said pair of contact carriers is a fixed contact, wherein said movable contact moves in the direction of said contact direction relative to said fixed contact during switching.

15. The switching device according to claim 1, wherein said switching device is bidirectional with respect to a load current.

16. The switching device according to claim 1, wherein the arrangement of said magnetic shielding guides the blowout magnetic field of said blowout magnet around said contact members and thereby attenuates the blowout magnetic field in the closed position of said contacts, via which, through the electromagnetic repulsion caused by high currents of greater than or equal to 15 kA, a contact gap is produced, in such a way that electric arc plasma cannot leave the contact gap produced by the electromagnetic repulsion.

17. The switching device according to claim 1, wherein, in the open position, a current of less than or equal to 2.5 kA between said contact member and said mating contact is interrupted.
